(19) United States
(12) Patent Application Publication
(10) Pub. No.: US 2014/0253710 A1
(43) Pub. Date: Sep. 11, 2014

(54) INFORMATION PROCESSING APPARATUS FOR WATCHING, INFORMATION PROCESSING METHOD AND NON-TRANSITORY RECORDING MEDIUM RECORDED WITH PROGRAM

(71) Applicant: NK WORKS CO., LTD., Wakayama-shi (JP)

(72) Inventors: Toru Yasukawa, Wakayama-shi (JP); Shoichi Dedachi, Wakayama-shi (JP); Takeshi Murai, Wakayama-shi (JP); Shuichi Matsumoto, Wakayama-shi (JP); Masayoshi Uetsuji, Wakayama-shi (JP)

(73) Assignee: NK WORKS CO., LTD., Wakayama-shi (JP)

(21) Appl. No.: 14/193,377

(22) Filed: Feb. 28, 2014

(30) Foreign Application Priority Data
Mar. 6, 2013 (JP) 2013-044557

(51) Int. Cl. H04N 7/18

(52) U.S. Cl. CPC H04N 7/18
USPC 348/77

(57) ABSTRACT

An information processing apparatus according to one aspect of the present invention is disclosed, which includes: an image acquiring unit acquiring moving images captured by a camera for watching a behavior of a watching target person on a bed or in the vicinity thereof; an image processing unit obtaining an optical flow within the moving images; and a behavior presuming unit, when detecting a moving-object based on the optical flow, assuming that the detected moving-object corresponds to the watching target person and presuming the behavior of the watching target person on the bed or in the vicinity thereof based on a position and a moving direction of the moving-object.

### FIELD

The present invention relates to an information processing apparatus for watching, an information processing method and a non-transitory recording medium recorded with a program.

### BACKGROUND

A technology (Japanese Patent Application Laid-Open Publication No. 2002-230533) exists, which determines a get-into-bed event by detecting a movement of a human body from a floor area into abed area in a way that passes through a frame border of an image captured from upward indoors to downward indoors, and determines a leaving-bed event by detecting a movement of the human body from the bed area down to the floor area.

Another technology (Japanese Patent Application Laid-Open Publication No. 2009-504293) exists, which prompts a user to perform a prepared motion according to an instruction, generates video image data in a format based on image sequences by recording a video image of the user, determining a degree of synchronicity between an optical flow of a left half of the body and an optical flow of a right half of the body in the image sequences by employing a computer system implementing a computer vision technology, and estimates a kinetic function of the user on the basis of a degree of the synchronicity.

Still another technology (Japanese Patent Application Laid-Open Publication No. 2011-005171) exists, which sets a watching area for detecting that a patient lying down on the bed conducts a behavior of getting up from the bed as an area immediately above the bed, which covers the patient sleeping in the bed, and determines that the patient conducts a behavior of getting up from the bed if a variation value representing a size of an image area of a deemed-to-be patient that occupies a watching area of a captured image covering the watching area from a crosswise direction of the bed, is less than an initial value representing a size of the image area of the deemed-to-be patient that occupies the watching area of a captured image obtained from a camera in a state of the patient lying down on the bed.

In recent years, there has been an annually increasing tendency of accidents that inpatients, care facility tenants, care receivers, etc fall down or come down from beds and of accidents caused by wandering of dementia patients. A watching system utilized in, e.g., a hospital, a care facility, etc is developed as a method of preventing those accidents. The watching system is configured to detect behaviors of a watching target person such as a get-up state, a sitting-on-bed-edge state and a leaving-bed state by capturing an image of the watching target person with a camera installed indoors and analyzing the captured image. This type of watching system involves using a comparatively high-level image processing technology such as a facial recognition technology for recognizing the watching target person, however, a problem inherent in the system lies in a difficulty of utilizing the system to adjust system settings corresponding to medical or nursing care sites.

### SUMMARY

An information processing apparatus according to one aspect of the present invention includes: an image acquiring unit to acquire moving images captured by a camera installed for watching a behavior of a watching target person on a bed or in the vicinity of the bed; an image processing unit to obtain an optical flow within the acquired moving images; and a behavior presuming unit to, when detecting a moving-object based on the obtained optical flow, assume that the detected moving-object corresponds to the watching target person and to presume the behavior of the watching target person on the bed or in the vicinity of the bed on the basis of a position and a moving direction of the detected moving-object.

According to the configuration described above, the optical flow is obtained from the moving images captured by the camera installed for watching the behavior of the watching target person on the bed or in the vicinity of the bed. Then, the moving-object based on the obtained optical flow is detected, in which case it is assumed that the detected moving-object corresponds to the watching target person, and the behavior of the watching target person on the bed or in the vicinity of the bed is presumed based on the position and the moving direction of the detected moving-object. Note that the watching target person connotes a target person whose behavior is watched by the information processing apparatus and is exemplified by an inpatient, a care facility tenant and a care receiver.

Hence, according to the configuration described above, the behavior of the watching target person is presumed based on the position and the moving direction of the moving-object detected based on the optical flow, and therefore the behavior of the watching target person can be presumed by a simple method without introducing a high-level image processing technology such as image recognition.

Further, by way of another mode of the information processing apparatus according to one aspect, the behavior presuming unit may presume that the watching target person gets up from the bed when detecting the moving-object moving in a get-up direction of the watching target person from within an upper-body detectable area potentially covering existence of an upper half of the body of the watching target person in a state of lying down on the bed. It is to be noted that the get-up direction connotes a direction in which the upper half of the body moves when the watching target person in a sleeping state (lying state) gets up.

According to the configuration described above, when presuming that the watching target person gets up from the bed, conditions of a starting point and the moving direction of the moving-object detected based on the optical flow are determined, and hence it is feasible to presume the get-up state on the bed with respect to the watching target person.

Moreover, by way of still another mode of the information processing apparatus according to one aspect, the behavior presuming unit may presume that the watching target person gets up from the bed when detecting the moving-object moving in the get-up direction of the watching target person from within the upper-body detectable area in a watching-target-person detectable area potentially covering the existence of the watching target person in the case of the watching target person behaving on the bed.

According to the configuration described above, there is narrowed down a range for detecting the moving-object on the basis of the optical flow when presuming the get-up state on the bed with respect to the watching target person. It is therefore feasible to enhance accuracy to presume the get-up state on the bed with respect to the watching target person.

Furthermore, by way of yet another mode of the information processing apparatus according to one aspect, the image processing unit may further detect a trajectory of the moving-object by tacking a motion in the detected moving images. Then, the behavior presuming unit may presume the get-up state on the bed with respect to the watching target person in distinction from a roll-over state on the bed with respect to the watching target person on the basis of the detected trajectory.

The optical flow represents motions between adjacent frames within the moving images but does not represent a series of motions of the moving-object, and hence there is a possibility of mis-presuming (misrecognizing) a roll-over state on the bed for the get-up state on the bed. According to the configuration described above, the get-up state can be presumed in distinction from the roll-over state on the bed on the basis of the trajectory from which the series of motions of the moving-object can be grasped. It is therefore possible to enhance the accuracy to presume the get-up state on the bed with respect to the watching target person.

Moreover, by way of yet another mode of the information processing apparatus according to one aspect, the behavior presuming unit, with a fence being provided on the bed, may presume an over-bed-fence state of the watching target person when detecting the moving-object moving to an outside from an inside of the watching-target-person detectable area potentially covering the existence of the watching target person in the case of the watching target person behaving on the bed.

According to the configuration described above, there are determined the conditions of the starting point and the moving direction of the moving-object detected based on the optical flow when presuming the over-bed-fence state of the watching target person, and it is therefore feasible to presume the over-bed-fence state of the watching target person.

Moreover, by way of a further mode of the information processing apparatus according to one aspect, the image processing unit may further detect a foreground area in the moving images by a background difference method of separating a foreground from a background. Then, the behavior presuming unit may presume the over-bed-fence state of the watching target person in distinction from a state in which a part of the body of the watching target person overreaches an edge of the bed by determining whether the foreground area detected in a moving-object area covering existence of the moving-object detected based on the optical flow exceeds a predetermined size or not.

When the body part overreaches the edge of the bed, there is a possibility of detecting the moving-object moving to the outside from the inside of the watching-target-person detectable area on the bed, which leads to a possibility of satisfying a condition for presuming the over-bed-fence state. In this case, however, a size of the foreground area extracted by the background difference method is assumed to be smaller than in the case of the over-bed-fence state where the entire body moves. According to the configuration described above, the over-bed-fence state of the watching target person is presumed in distinction from the state in which the body part of the watching target person overreaches the edge of the bed by determining whether the foreground area detected in the moving-object area covering existence of the moving-object detected based on the optical flow exceeds the predetermined size or not. Therefore, it is feasible to enhance the accuracy to presume the over-bed-fence state of the watching target person.

Moreover, by way of a yet further mode of the information processing apparatus according to one aspect, the behavior presuming unit may presume a sitting-on-bed-edge state of the watching target person when detecting the moving-object including a body part moving to an edge from the inside of the watching-target-person detectable area potentially covering the existence of the watching target person in the case of the watching target person behaving on the bed and a body part moving to the outside from the inside of the watching-target-person detectable area. Note that the sitting-on-bed-edge state connotes a state in which the watching target person sits on the edge of the bed.

According to the configuration described above, there are determined the conditions of the starting point and the moving direction of the moving-object detected based on the optical flow when presuming the sitting-on-bed-edge state of the watching target person, and it is therefore feasible to presume the sitting-on-bed-edge state of the watching target person.

Furthermore, by way of a still yet further mode of the information processing apparatus according to one aspect, the image processing unit may further specify the foreground area in the moving images by the background difference method of separating the foreground from the background. Then, the behavior presuming unit may presume the sitting-on-bed-edge state of the watching target person in distinction from a state in which a part of the body of the watching target person overreaches an edge of the bed by determining whether the foreground area detected in a moving-object area covering existence of the moving-object detected based on the optical flow exceeds a predetermined size or not.

When the body part overreaches the edge of the bed, there is a possibility of detecting the moving-object including the body part moving to the edge from the inside of the watching-target-person detectable area on the bed and the body part moving to the outside from the inside of the watching-target-person detectable area, which leads to a possibility of satisfying the condition for presuming the sitting-on-bed-edge state. In this case, however, the size of the foreground area extracted by the background difference method is assumed to be smaller than in the case of the sitting-on-bed-edge state where the entire body moves. According to the configuration described above, the sitting-on-bed-edge state of the watching target person is presumed in distinction from the state in which the body part of the watching target person overreaches the edge of the bed by determining whether the foreground area detected in the moving-object area covering existence of the moving-object detected based on the optical flow exceeds the predetermined size or not. Therefore, it is feasible to enhance the accuracy to presume the sitting-on-bed-edge state of the watching target person.

Moreover, by way of a yet further mode of the information processing apparatus according to one aspect, the behavior presuming unit may presume the leaving-bed state of the watching target person when detecting the moving-object moving outwardly of the watching-target-person detectable area potentially covering the existence of the watching target person in the case of the watching target person behaving on the bed.

According to the configuration described above, there are determined the conditions of the starting point and the moving direction of the moving-object detected based on the optical flow when presuming the leaving-bed state of the watching target person, and it is therefore feasible to presume the leaving-bed state of the watching target person.

Further, by way of an additional mode of the information processing apparatus according to one aspect, the image processing unit may further specify the foreground area in the moving images by the background difference method of separating the foreground from the background. Then, the behavior presuming unit may presume that the watching target person comes down from the bed when the foreground area detected by the background difference method disappears with an elapse of time after detecting the moving-object moving beneath the bed from the inside of the watching-target-person detectable area potentially covering the existence of the watching target person in the case of the watching target person behaving on the bed.

Supposing that the watching target person comes down from the bed and stays in this come-down position, it is assumed that the watching target person is treated as an element of the background in the come-down position. According to the configuration described above, there are determined the conditions of the starting point and the moving direction of the moving-object detected based on the optical flow when presuming the come-down state from the bed with respect to the watching target person, and a condition conforming to the assumption of the foreground area detected by the background difference method. Hence, the configuration described above enables the presumption of the come-down state from the bed with respect to the watching target person.

Furthermore, by way of a still additional mode of the information processing apparatus according to one aspect, the behavior presuming unit may presume the behavior of the watching target person on the bed or in the vicinity of the bed further on the basis of a depth of the moving-object, which is obtained by a depth sensor.

A position of the detected moving-object in a real space cannot be necessarily specified from the moving images. For this reason, the detected moving-object corresponds not to the behavior of the watching target person existing on the bed or in the vicinity of the bed but to a motion of an object existing on the near side of the watching target person as viewed from the camera as the case may be. By contrast, according to the configuration described above, the depth sensor can obtain the depth of the moving-object, thereby making it possible to determine whether or not the detected moving-object corresponds to the behavior of the watching target person existing on the bed or in the vicinity of the bed. Namely, it is feasible to set a condition of the depth of the area in which the moving-object is detected when presuming each behavior. Therefore, according to the configuration described above, it is possible to enhance the accuracy when presuming the behavior of the watching target person on the bed or in the vicinity of the bed.

Furthermore, by way of a yet still additional mode of the information processing apparatus according to one aspect, the information processing apparatus may include a notifying unit to issue notification for informing a symptom to a watcher for watching the watching target person when the presumed behavior of the watching target person implies the symptom that the watching target person will encounter with an impending danger.

According to the configuration described above, the watcher can be notified of the symptom that the watching target person will encounter with the impending danger. Further, the watching target person can be also notified of the symptom of the impending danger. Note that the watcher is the person who watches the behavior of the watching target person and is exemplified by a nurse, care facility staff and a caregiver if the watching target persons are the inpatient, the care facility tenant, the care receiver, etc. Moreover, the notification for informing of the symptom that the watching target person will encounter with the impending danger may be issued in cooperation with equipment installed in a facility such as a nurse call system.

It is to be noted that another mode of the information processing apparatus according to one aspect may be an information processing system realizing the respective configurations described above, may also be an information processing method, may further be a program, and may yet further be a non-transitory storage medium recording a program, which can be read by a computer, other apparatuses and machines. Herein, the recording medium readable by the computer etc is a medium that accumulates the information such as the program electrically, magnetically, mechanically or by chemical action. Moreover, the information processing system may be realized by one or a plurality of information processing systems.

For example, an information processing method according to one aspect of the present invention is a method by which a computer executes: acquiring moving images captured by a camera installed for watching a behavior of a watching target person on a bed or in the vicinity of the bed; obtaining an optical flow within the acquired moving images; and assuming, when detecting a moving-object based on the obtained optical flow, that the detected moving-object corresponds to the watching target person, and presuming the behavior of the watching target person on the bed or in the vicinity of the bed on the basis of a position and a moving direction of the detected moving-object.

Further, for example, a non-transitory recording medium according to one aspect of the present invention records a program to make a computer execute: acquiring moving images captured by a camera installed for watching a behavior of a watching target person on a bed or in the vicinity of the bed; obtaining an optical flow within the acquired moving images; and assuming, when detecting a moving-object based on the obtained optical flow, that the detected moving-object corresponds to the watching target person, and presuming the behavior of the watching target person on the bed or in the vicinity of the bed on the basis of a position and a moving direction of the detected moving-object.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a view illustrating one example of a situation to which the present invention is applied;

FIG. 2 is a diagram illustrating a hardware configuration of an information processing apparatus according to an embodiment;

FIG. 3 is a diagram illustrating a functional configuration of the information processing apparatus according to the embodiment;

FIG. 4 is a flowchart illustrating a processing procedure of the information processing apparatus according to the embodiment;

FIG. 5 is a view illustrating one example of an optical flow detected when a watching target person gets up from a bed;

FIG. 6 is a view illustrating an example of setting an watching-target-person detectable area according to the embodiment;

FIG. 7 is a view illustrating one example of a trajectory detected when the watching target person gets up from the bed;

FIG. 8 is a view illustrating one example of a trajectory detected when the watching target person rolls over in the bed;

FIG. 9 is a view illustrating one example of an optical flow detected when the watching target person moves over a fence of the bed;

FIG. 10 is a view illustrating one example of an optical flow detected when the watching target person becomes a sitting-on-bed-edge state;

FIG. 11 is a view illustrating one example of an optical flow detected when the watching target person leaves the bed; and

FIG. 12 is a view illustrating one example of an optical flow detected when the watching target person comes down from the bed.

### DESCRIPTION OF EMBODIMENT

An embodiment (which will hereinafter be also termed “the present embodiment”) according to one aspect of the present invention will hereinafter be described based on the drawings. However, the present embodiment, which will hereinafter be explained, is no more than an exemplification of the present invention in every point. As a matter of course, the invention can be improved and modified in a variety of forms without deviating from the scope of the present invention. Namely, on the occasion of carrying out the present invention, a specific configuration corresponding to the embodiment may properly be adopted.

Note that data occurring in the present embodiment are, though described in a natural language, specified more concretely by use of a quasi-language, commands, parameters, a machine language, etc, which are recognizable to a computer.

### §1 Example of Applied Situation

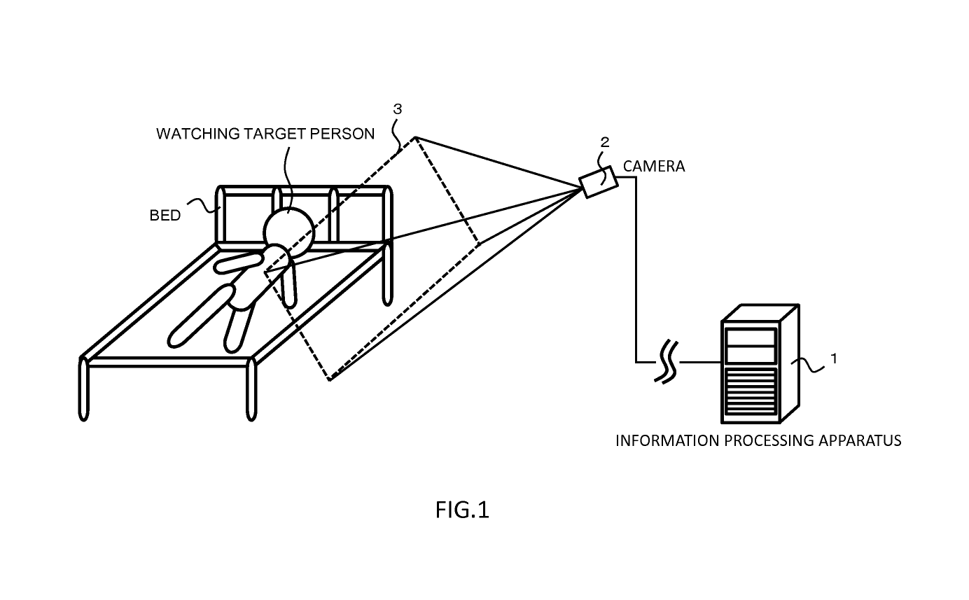

FIG. 1 illustrates one example of a situation to which the present invention is applied. The present embodiment assumes a situation of watching a behavior of an inpatient in a medical treatment facility or a tenant in a nursing facility as a watching target person. An image of the watching target person is captured by a camera 2 installed on a right side of a bed in a lateral direction, thus watching a behavior thereof.

The camera 2 is installed for watching the behaviors of the watching target person on the bed and in the vicinity of the bed. The camera 2 captures images of how the watching target person behaves on the bed and in the vicinity of the bed. Note that a type of the camera 2 and a disposing position thereof may be properly selected corresponding to the embodiment. Moving images 3 captured by the camera 2 are transmitted to an information processing apparatus 1.

The information processing apparatus 1 according to the present embodiment, when acquiring the moving images 3 from the camera 2, obtains an optical flow within the acquired moving images 3. Specifically, the optical flow expresses moving quantities (flow vectors) of the same object in vector data which are associated between two frames of the images captured at different points of time. Therefore, the moving quantities of the object projected within the moving images 3 are expressed by the optical flow. Hence, the moving-object moving within the moving images 3 can be detected by use of the optical flow.

This being the case, when detecting the moving-object based on the obtained optical flow, the information processing apparatus 1 according to the present embodiment assumes that the detected moving-object corresponds to the watching target person, and presumes the behavior of the watching target person on the bed or in the vicinity of the bed on the basis of a position and a moving direction of the detected moving-object.

Thus, according to the present embodiment, the optical flow is obtained from the moving images 3 captured by the camera 2 installed for watching the behaviors of the watching target person on the bed and in the vicinity of the bed. Then, when the moving moving-object is detected based on the thus-obtained optical flow, it is assumed that the detected moving-object corresponds to the watching target person, and the behavior of the watching target person on the bed or in the vicinity of the bed is presumed based on the position and the moving direction of the detected moving-object.

Hence, according to the present embodiment, the behavior of the watching target person on the bed or in the vicinity of the bed can be presumed based on the position and the moving direction of the moving-object detected by the optical flow obtained from the moving images 3. Therefore, the behavior of the watching target person can be presumed by a simple method without introducing a high-level image processing technology such as the image recognition.

Note that the information processing apparatus 1 according to the present embodiment presumes the behavior of the watching target person on the bed or in the vicinity of the bed, and can be therefore utilized as an apparatus for watching an inpatient, a care facility tenant, a care receiver, etc in a hospital, a care facility and so on. Herein, the behavior of the watching target person on the bed or in the vicinity of the bed may be properly set corresponding to the embodiment. In the present embodiment, examples of the behaviors of the watching target person on the bed and in the vicinity of the bed can be given such as a get-up state on the bed, an over-bed-fence state, a sitting-on-bed-edge state, a leaving-bed state and a come-down state from the bed. An in-depth description thereof will be made later on.

Further, a method of obtaining the optical flow may be properly selected corresponding to the embodiment. Methods, which can be given by way of examples of the method of obtaining the optical flow, are a block matching method of obtaining the optical flow by use of, e.g., template matching and a gradient-based approach for obtaining the optical flow by utilizing a constraint of space-time derivation.

### §2 Example of Configuration

### Example of Hardware Configuration

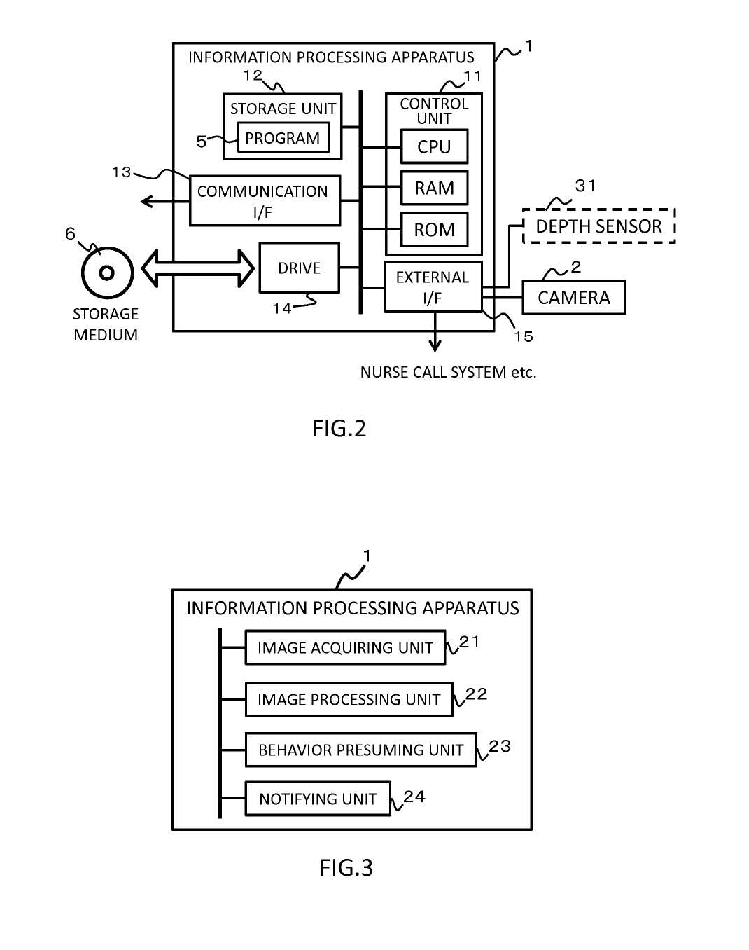

FIG. 2 illustrates a hardware configuration of the information processing apparatus 1 according to the present embodiment. The information processing apparatus 1 is a computer including: a control unit 11 containing a CPU, a RAM (Random. Access Memory) and a ROM (Read Only Memory); a storage unit 12 storing a program 5 etc executed by the control unit 11; a communication interface 13 for performing communications via a network; a drive 14 for reading a program stored on a storage medium 6; and an external interface 15 for establishing a connection with an external device, which are all electrically connected to each other.

Note that as for the specific hardware configuration of the information processing apparatus 1, the components thereof can be properly omitted, replaced and added corresponding to the embodiment. For instance, the control unit 11 may include a plurality of processors. Furthermore, the information processing apparatus 1 may be equipped with output devices such as a display and input devices for inputting such as a mouse and a keyboard. Note that the communication interface and the external interface are abbreviated to the “communication I/F” and the “external I/F” respectively in FIG. 2.

Moreover, the information processing apparatus 1 may include a plurality of external interfaces 15 and may be connected to external devices through these interfaces 15. In the present embodiment, the information processing apparatus 1 may be connected to the camera 2, which captures the image of the watching target person and the image of the bed, via the external I/F 15. Further, the information processing apparatus 1 maybe connected to a depth sensor 31 for measuring a depth within the moving images 3 via the external I/F 15. Still further, the information processing apparatus 1 is connected via the external I/F 15 to equipment installed in a facility such as a nurse call system, whereby notification for informing of a symptom that the watching target person will encounter with an impending danger may be issued in cooperation with the equipment.

Moreover, the program 5 is a program for making the information processing apparatus 1 execute steps contained in the operation that will be explained later on, and corresponds to a “program” according to the present invention. Moreover, the program 5 may be recorded on the storage medium 6. The storage medium 6 is a non-transitory medium that accumulates information such as the program electrically, magnetically, optically, mechanically or by chemical action so that the computer, other apparatus and machines, etc can read the information such as the recorded program. The storage medium 6 corresponds to a “non-transitory storage medium” according to the present invention. Note that FIG. 2 illustrates a disk type storage medium such as a CD (Compact Disk) and a DVD (Digital Versatile Disk) by way of one example of the storage medium 6. It does not, however, mean that the type of the storage medium 6 is limited to the disk type, and other types excluding the disk type may be available. The storage medium other than the disk type can be exemplified by a semiconductor memory such as a flash memory.

Further, the information processing apparatus 1 may involve using, in addition to, e.g., an apparatus designed for an exclusive use for a service to be provided, general-purpose apparatuses such as a PC (Personal Computer) and a tablet terminal. Further, the information processing apparatus 1 may be implemented by one or a plurality of computers.

### Example of Functional Configuration

FIG. 3 illustrates a functional configuration of the information processing apparatus 1 according to the present embodiment. The CPU provided in the information processing apparatus 1 according to the present embodiment deploys the program 5 on the RAM, which is stored in the storage unit 12. Then, the CPU interprets and executes the program 5 deployed on the RAM, thereby controlling the respective components. Through this operation, the information processing apparatus 1 according to the present embodiment functions as the computer including an image acquiring unit 21, an image processing unit 22, a behavior presuming unit 23 and a notifying unit 24.

The image acquiring unit 21 acquires the moving images 3 captured by the camera 2 installed for watching the behaviors of the watching target person on the bed and in the vicinity of the bed. The image processing unit 22 obtains the optical flow within the acquired moving images 3. Then, the behavior presuming unit 23, when detecting the moving-object based on the obtained optical flow, assumes that the detected moving-object corresponds to the watching target person, and presumes the behavior of the watching target person on the bed or in the vicinity of the bed on the basis of the position and the moving direction of the detected moving-object.

Note that the behavior presuming unit 23, when detecting the moving-object moving in a get-up direction of the watching target person from within an upper-body detectable area potentially covering existence of an upper half of the body of the watching target person in a state of lying down on the bed, may presume that the watching target person gets up. The “get-up direction” connotes a direction in which the upper half of the body moves when the watching target person in the lying state gets up. The upper-body detectable area and the get-up direction may be, e.g., set on ahead, may also be set by a user (e.g., a watcher) utilizing the information processing apparatus 1 and may further be set by the user in a manner that selects this area from given patterns.

Further, the behavior presuming unit 23 may presume that the watching target person gets up from the bed when detecting the moving-object moving in the get-up direction of the watching target person from within the upper-body detectable area in an watching-target-person detectable area potentially covering the existence of the watching target person in such a case that the watching target person behaves on the bed.

Moreover, the image processing unit 22 may further detect a trajectory of the moving-object by tracking a motion in the acquired moving images 3. Then, the behavior presuming unit 23 may presume that watching target person gets up from the bed by distinguishing from the watching target person rolling over on the bed on the basis of the detected trajectory.

Moreover, the behavior presuming unit 23 may presume that the watching target person moves over a fence of the bed when detecting the moving-object moving to an outside from an inside of the watching-target-person detectable area potentially covering the existence of the watching target person in the case of the watching target person behaving on the bed on the occasion of providing the fence on the bed. Herein, it may be properly set corresponding to the embodiment whether the fence is provided on the bed or not. For example, the user (e.g., the watcher) utilizing the information processing apparatus 1 may make this setting.

Furthermore, the image processing unit 22 may further detect a foreground area in the acquired moving images 3 by a background difference method of separating a foreground from a background. Then, the behavior presuming unit 23 may presume the over-bed-fence state of the watching target person in distinction from a state in which a body part of the watching target person overreaches an edge of the bed by determining whether or not the foreground area detected in the moving-object area covering the existence of the moving-object detected based on the optical flow exceeds a predetermined size.

Further, the behavior presuming unit 23 may presume a sitting-on-bed-edge state of the watching target person when detecting the moving-object including a body part moving to the edge from the inside of the watching-target-person detectable area potentially covering the existence of the watching target person in the case of the watching target person behaving on the bed and a body part moving to the outside from the inside of the watching-target-person detectable area. Note that the sitting-on-bed-edge state represents a state in which the watching target person sits on the edge of the bed.

Moreover, the image processing unit 22 may further specify the foreground area in the acquired moving images 3 by the background difference method of separating the foreground from the background. Then, the behavior presuming unit 23 may presume the sitting-on-bed-edge state of the watching target person in distinction from the state in which the body part of the watching target person overreaches the edge of the bed by determining whether or not the foreground area in the moving-object area covering the existence of the moving-object detected based on the optical flow exceeds the predetermined size.

Further, the behavior presuming unit 23 may presume the leaving-bed state of the watching target person when detecting the moving-object moving outside the watching-target-person detectable area potentially covering the existence of the watching target person in the case of the watching target person behaving on the bed.

Furthermore, the image processing unit 22 may further specify the foreground area in the acquired moving images 3 by the background difference method of separating the foreground from the background. Then, the behavior presuming unit 23 may presume the come-down state from the bed with respect to the watching target person when the foreground area detected by the background difference method disappears with an elapse of time after detecting the moving-object moving beneath the bed from the inside of the watching-target-person detectable area potentially covering the existence of the watching target person in the case of the watching target person behaving on the bed.

Moreover, the behavior presuming unit 23 may presume the behavior of the watching target person on the bed or in the vicinity of the bed further on the basis of a depth of the moving-object that is acquired by the depth sensor 31.

Further, the information processing apparatus 1 according to the present embodiment includes the notifying unit for issuing, if the presumed behavior of the watching target person is the behavior indicating the symptom that the watching target person will encounter with the impending danger, the notification for informing the symptom to the watcher who watches the watching target person. Herein, the watcher is the person who watches the behavior of the watching target person and is exemplified by a nurse, staff and a caregiver if the watching target persons are the inpatient, the care facility tenant, the care receiver, etc. Moreover, the notification for informing of the symptom that the watching target person will encounter with the impending danger may be issued in cooperation with equipment installed in a facility such as a nurse call system.

It is to be noted that the present embodiment discusses the example in which each of these functions is realized by the general-purpose CPU. Some or the whole of these functions may, however, be realized by one or a plurality of dedicated processors. For example, in the case of not issuing the notification for informing of the symptom that the watching target person will encounter with the impending danger, the notifying unit 24 may be omitted.

### §3 Operational Example

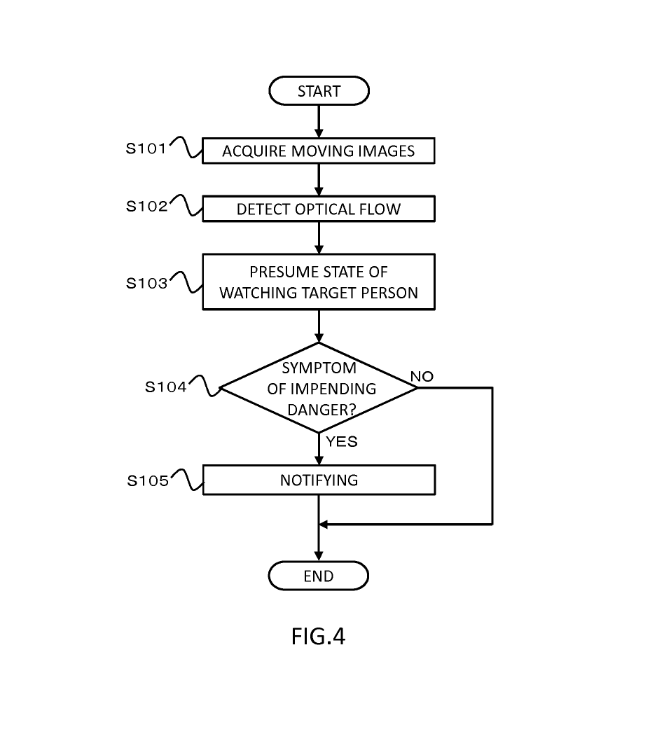

FIG. 4 illustrates an operational example of the information processing apparatus 1 according to the present embodiment. It is to be noted that a processing procedure of the operational example given in the following discussion is nothing but one example, and the respective processes may be replaced to the greatest possible degree. Further, as for the processing procedure of the operational example given in the following discussion, the processes thereof can be properly omitted, replaced and added corresponding to the embodiment. For instance, in the case of not issuing the notification for informing of the symptom that the watching target person will encounter with the impending danger, steps S104 and S105 may be omitted.

<Step S101>

In step S101, the control unit 11 functions as the image acquiring unit 21 and acquires the moving images 3 from the camera 2 installed for watching the behaviors of the watching target person on the bed and in the vicinity of the bed. The moving images 3 acquired by the control unit 11 from the camera 2 contain the images of how the watching target person behaves on the bed and in the vicinity of the bed.

Note that the information processing apparatus 1 according to the present embodiment is utilized for watching the inpatient or the care facility tenant in the medical treatment facility or the care facility. In this case, the control unit 11 may obtain the image in a way that synchronizes with the video signals of the camera 2. Then, the control unit 11 may promptly execute the processes instep 5102 through step S105, which will be described later on, with respect to the acquired image. The information processing apparatus 1 consecutively executes this operation without interruption, thereby realizing real-time image processing and enabling the behaviors of the inpatient or the care facility tenant to be watched in real time.

<Step S102>

In step S102, the control unit 11 functions as the image processing unit 22 and obtains the optical flow within the moving images 3 acquired in step S101. The method of obtaining the optical flow may be, as described above, properly selected corresponding to the embodiment. Methods, which can be given byway of examples of the method of obtaining the optical flow, are a block matching method of obtaining the optical flow by use of, e.g., template matching and a gradient-based approach for obtaining the optical flow by utilizing a constraint of space-time derivation.

<Step S103>

In step S103, the control unit 11 functions as the behaving presuming unit 23. The behavior presuming unit 23, when detecting the moving-object based on the optical flow obtained in step S102, assumes that the detected moving-object corresponds to the watching target person, and presumes the behavior of the watching target person on the bed or in the vicinity of the bed on the basis of the position and the moving direction of the detected moving-object. In the present embodiment, the control unit 11 presumes at least any one of the behaviors of the watching target on the bed and in the vicinity of the bed such as the get-up state on the bed, the over-bed-fence state, the sitting-on-bed-edge state, the leaving-bed state and the come-down state from the bed. The presumptions of the respective behaviors will hereinafter be described by giving concrete examples with reference to the drawings.

(a) Get-Up State

FIG. 5 illustrates one example of the optical flow detected when the watching target person gets up from the bed. Supposing that the watching target person gets up, as depicted in FIG. 5, from a state of sleeping with the body lying in his or her back (a face-up position) on the bed, it is assumed that a motion occurs in the area where the upper half of the body of the watching target person is projected within the moving images 3. Therefore, in step S102, during a transition of a posture of the watching target person to the get-up state from the face-up position, it can be assumed that the optical flow as illustrated in FIG. 5 is to be detected.

Such being the case, in step S103, the control unit 11 presumes that the watching target person gets up from the bed when detecting the moving-object moving in the get-up direction of the watching target person from within a predetermined area (upper-body detectable area) potentially covering the existence of the upper half of the body of the watching target person in the state of lying down on the bed.

To give the concrete example, if possible of detecting the optical flow in the get-up direction or in a direction that can approximate to the get-up direction continuously for a predetermined or longer period of time within the predetermined area or in the vicinity thereof after detecting the optical flow in the get-up direction or in the direction that can approximate to the get-up direction, the control unit 11 estimates that it is possible to detect the moving-object moving in the get-up direction from within the predetermined area, and may presume that watching target person gets up from the bed.

Herein, the predetermined area is set as the upper-body detectable area potentially covering the existence of the upper half of the body of the watching target person in order to presume that the watching target person gets up from the bed. The predetermined area may be set on ahead, may also set by the user (e.g., the watcher) in the way of being designated and may further be set by the user in a way that selects this area from given patterns. The predetermined area is properly set corresponding to the embodiment. Herein, FIG. 5 depicts the predetermined area in an elliptical shape. However, the shape of the predetermined area is not limited to the elliptical shape but may be properly set corresponding to the embodiment.

Moreover, the predetermined period of time serves as an index for estimating whether or not the optical flow is continuously detected when presuming the get-up state of the watching target person. The predetermined period of time may be set beforehand, may also be set by the user, may further be set by the user in a way that selects the time from given periods of time and may yet further be properly set corresponding to the embodiment.

Moreover, the get-up direction is a direction in which the upper half of the body moves up when the watching target person in the sleeping state gets up. The get-up direction may be set on ahead, may also be set by the user, may further be set by the user in a manner that selects this direction from given patterns and may yet further be properly set corresponding to the embodiment.

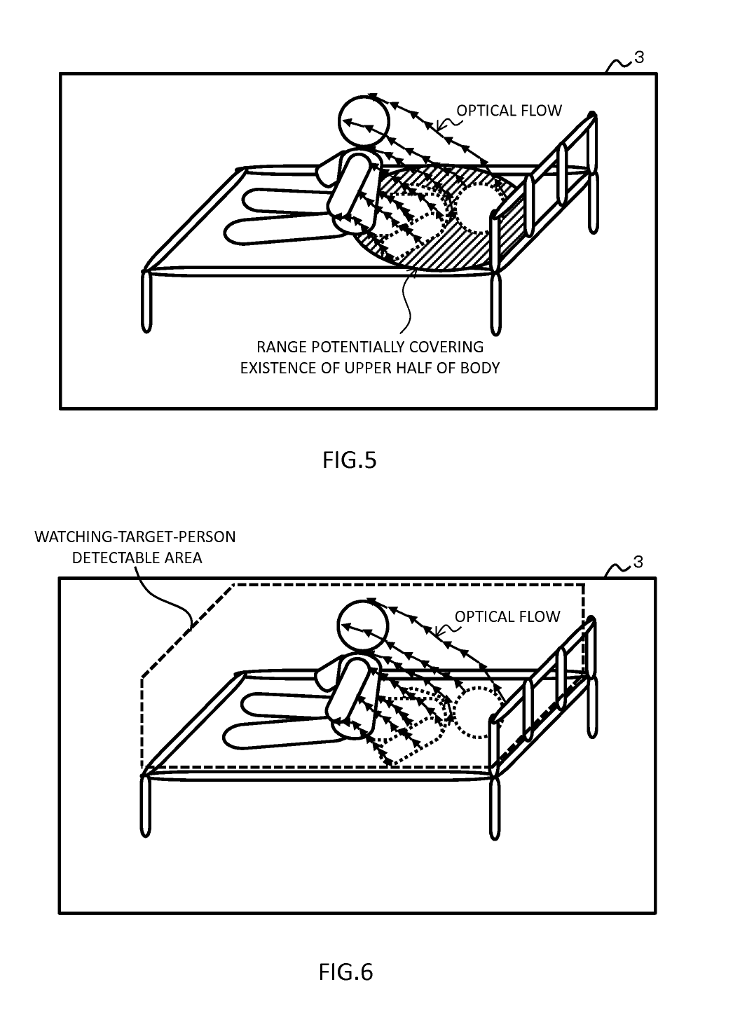

FIG. 6 illustrates a situation of setting the watching-target-person detectable area which potentially covers the existence of the watching target person when the watching target person behaves on the bed. If not confining the area in which to detect the optical flow serving as the reference for presuming the behavior of the watching target person within the moving images 3, there is a possibility of making an erroneous presumption based on an optical flow of a moving-object unrelated to the motion of the watching target person.

This being the case, in step S103, the control unit 11 may presume that the watching target person gets up from the bed when detecting the moving-object moving in the get-up direction of the watching target person from within the predetermined area (upper-body detectable area) in the watching-target-person detectable area. In other words, the control unit 11 may confine an existence potential range of the optical flow contributing to presume that the watching target person gets up from the bed.

With this contrivance, the behavior of the watching target person can be presumed by excluding the optical flows unrelated to the behavior of the watching target person on the bed and by limiting the flows to the optical flow assumed to be related to the behavior of the watching target person on the bed. For that reason, the control unit 11 is thus made to operate, whereby it is feasible to enhance the accuracy of presuming that the watching target person gets up from the bed.

Note that the watching-target-person detectable area is for excluding the optical flows unrelated to the behavior of the watching target person on the bed and for limiting the flows to the optical flow assumed to be related to the behavior of the watching target person on the bed. The watching-target-person detectable area maybe set on ahead, may also be set by the user, may further be set by the user in a manner that selects this area from given patterns and may yet further be properly set corresponding to the embodiment.

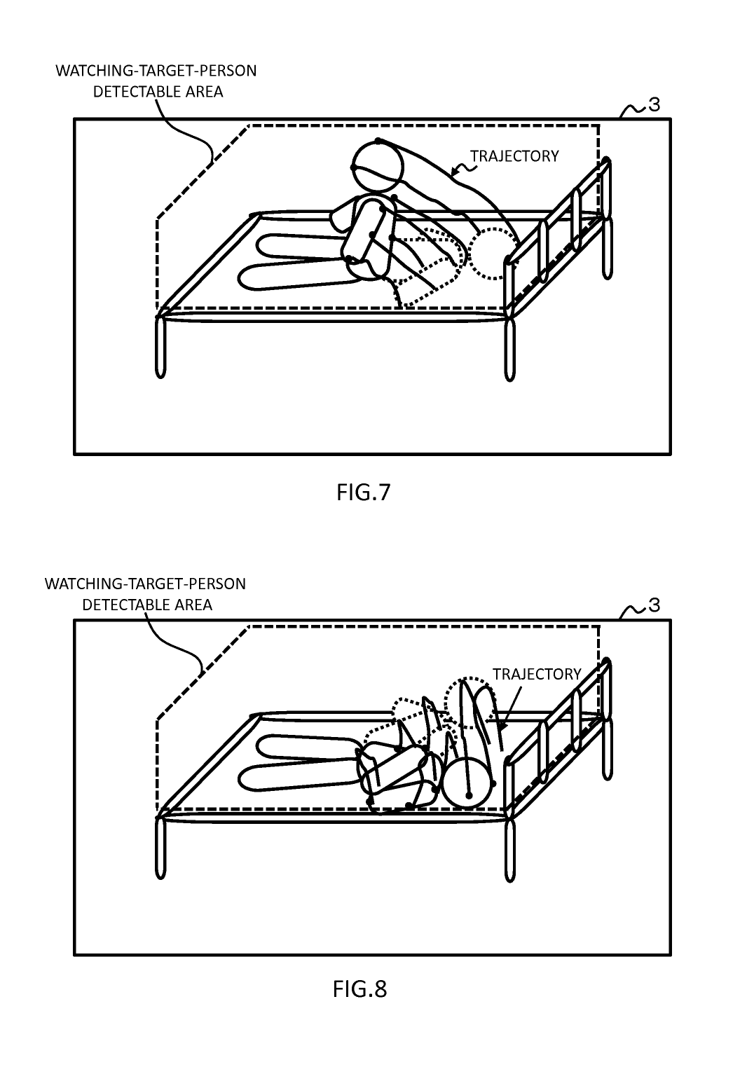

FIG. 7 illustrates one example of a trajectory detected when the watching target person gets up from the bed. FIG. 8 illustrates one example of a trajectory detected when the watching target person rolls over on the bed. The roll-over state and the get-up state on the bed have a possibility common to the movement of the upper half of the body. Therefore, such a possibility exists that an optical flow having a tendency similar to a tendency of the optical flow detected when getting up from the bed is detected when rolling over on the bed. Then, the optical flow represents motions between the adjacent frames within the moving images but does not represent a series of motions of the moving-object, and hence the control unit 11 has a possibility of mis-presuming (misrecognizing) the roll-over state on the bed for the get-up state on the bed.

This being the case, the control unit 11 functions as the image processing unit 22, and may further detect the trajectory of the moving-object by tracking the motions in the acquired moving images 3. Then, the control unit 11 functions as the behavior presuming unit 23, and may presume the get-up state on the bed with respect to the watching target person in distinction from the roll-over state on the bed with respect to the watching target person on the basis of the detected trajectory. The get-up state can be thereby presumed in distinction from the roll-over state on the bed on the basis of the trajectory from which the series of motions of the moving-object can be captured, thereby enabling enhancement of the accuracy when presuming the get-up state on the bed with respect to the watching target person.

Note that the trajectory of the motions may be properly acquired corresponding to the embodiment. The control unit 11 may acquire the trajectory of the motions based on, e.g., a moving point obtained on the occasion of detecting the optical flow. To be specific, the control unit 11 sets a fixed frame of area with the moving point being centered as a tracking area. Then, the control unit 11, in a frame next to the frame with the tracking area being set, performs template matching of the tracking area within a fixed range taking account of the movement. The control unit 11, if an area exceeding a fixed matching rate can be detected based on the template matching, determines that the tracking gets successful, and continues the tracking. Whereas if the area exceeding the fixed matching rate cannot be detected, the control unit 11 determines that the tracking gets unsuccessful, and finishes the tracking. The control unit 11 can acquire the trajectory of the motion from a start of the tracking to an end thereof by performing the tracking such as this.

Furthermore, a condition for distinguishing between the roll-over state and the get-up state of the watching target person on the basis of the acquired trajectory may be properly set corresponding to the embodiment. For instance, as depicted in FIGS. 7 and 8, the get-up state can be assumed to be a unidirectional moving behavior, while the roll-over state can be assumed not to be necessarily the unidirectional moving behavior. Based on these assumptions, the control unit 11, if it can be estimated that the detected trajectory indicates the unidirectional movement, may presume that the watching target person gets up from the bed. Whereas if it cannot be estimated that the detected trajectory indicates the unidirectional movement, the control unit 11 may presume that the watching target person rolls over on the bed.

(b) Over-Bed-Fence State

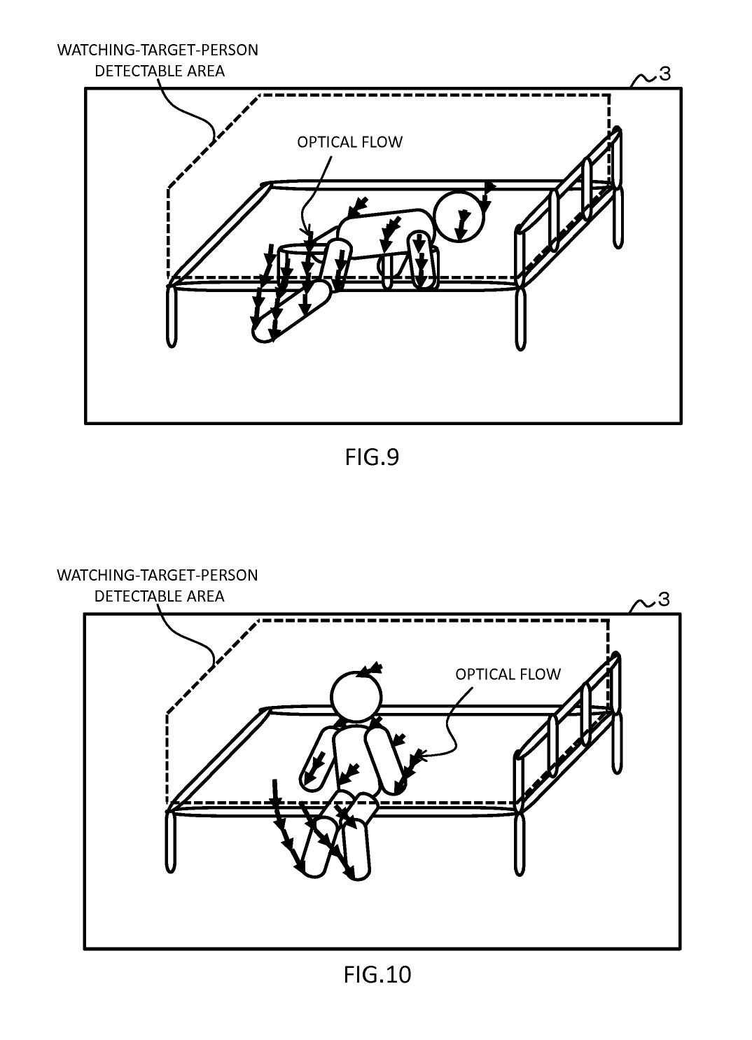

FIG. 9 illustrates one example of the optical flow detected when the watching target person moves over the fence of the bed. As depicted in FIG. 9, if the watching target person tries to move over the bed fence, it is assumed that a motion occurs in the vicinity of the fence provided at the edge of the bed in the moving images 3 acquired in step S101. It can be therefore assumed in step S102 that the watching target person tries to move over the bed fence, during which the optical flow as illustrated in FIG. 9 is detected. Note that FIG. 9 illustrates a situation where the watching target person tries to move over the bed fence provided at the edge on the near side of the camera.

Thereupon, in step S103, when detecting the moving-object moving to the outside from the inside of the watching-target-person detectable area described above on the occasion of providing the fence on the bed, the control unit 11 presumes the over-bed-fence state of the watching target person. As described above, the watching-target-person detectable area is set for excluding the optical flows unrelated to the behavior of the watching target person on the bed and for limiting the flows to the optical flow assumed to be related to the behavior of the watching target person on the bed. Namely, the watching-target-person detectable area defines a behavior range of the watching target person on the bed. Hence, it can be assumed that the behavior moving to the outside from the inside of the watching-target-person detectable area is a behavior moving outwardly of the bed from on the bed. Accordingly, if this condition is satisfied on the occasion of providing the fence on the bed, it can be assumed that the watching target person tries to move over the bed fence.

To give a specific example of this process, the optical flow toward the outside from the inside of the watching-target-person detectable area is detected in the vicinity of the edge of the watching-target-person detectable area on the occasion of providing the fence on the bed, and thereafter the optical flow is detected in this direction continuously for a predetermined or longer period of time and can be eventually detected outside the watching-target-person detectable range, in which case the control unit 11 estimates that the moving-object moving to the outside from the inside of the watching-target-person detectable area can be detected, and may presume the over-bed-fence state of the watching target person.

Note that the predetermined period of time serves as an index for estimating whether or not the optical flow is continuously detected when presuming the over-bed-fence state of the watching target person. The predetermined period of time may be set beforehand, may also be set by the user, may further be set by the user in a way that selects the time from given periods of time and may yet further be properly set corresponding to the embodiment.

Incidentally, it may be properly set corresponding to the embodiment whether the fence is provided on the bed or not. For example, this setting may also be done by the user. Moreover, if a computer controls the setting about the bed, the information processing apparatus 1 may acquires information on whether the fence is provided on the bed or not from the computer that controls the setting about the bed.

Moreover, the control unit 11 may make a determination about such a behavior based on the trajectory described above. For instance, the control unit 11 retains the template, related to the trajectory of the behavior, for presuming the over-bed-fence state, and may determine whether the watching target person is in the over-bed-fence state or not by judging whether the acquired trajectory matches with the template or not. Note that the same as this point is applied to the sitting-on-bed-edge state, the leaving-bed state and the come-down state that will be described below.

Herein, if the body part overreaches the edge of the bed, such a possibility exists that the moving-object moving to the outside from the inside of the watching-target-person detectable area on the bed is detected. This situation has a possibility of satisfying the condition for presuming the over-bed-fence state. In this case, however, a size of the foreground area extracted by the background difference method is assumed to be smaller than in the case of the over-bed-fence state where the entire body moves.

Such being the case, the control unit 11 functions as the image processing unit 22, and may detect the foreground area in the acquired moving images 3 by the background difference method of separating the foreground from the background. Then, the control unit 11 functions as the behavior presuming unit 23, and may presume the over-bed-fence state of the watching target person in distinction from such a state that the body part of the watching target person overreaches the edge of the bed by determining whether or not the foreground area detected in the moving-object area covering the existence of the moving-object detected based on the optical flow exceeds the predetermined size.

Specifically, if the foreground area in the moving-object area does not exceed the predetermined size, the control unit may presume that the watching target person is in the state of the body part overreaching the edge of the bed. Whereas if the foreground area in the moving-object area exceeds the predetermined size, the control unit may presume not the state where the body part of the watching target person overreaches the edge of the bed but the state where the watching target person tries to move over the bed fence.

This contrivance makes it feasible to presume the over-bed-fence state of the watching target person in distinction from the state in which the body part of the watching target person overreaches the edge of the bed. It is therefore possible to enhance the accuracy when presuming the over-bed-fence state of the watching target person.

Note that a background/foreground separating method based on the background difference method may be properly selected corresponding to the embodiment. For example, the background/foreground separating method can be exemplified by a method of separating the foreground from the background on the basis of a difference between a background image and an input image, a method of separating the foreground from the background by using three different frames of image and a method of separating the foreground from the background by applying a statistical model.

Further, the control unit 11 may presume the over-bed-fence state of the watching target person without depending on whether or not the fence is provided on the bed. This case has a possibility that the optical flow detected as the over-bed-fence state is similar to the optical flow detected as the sitting-on-bed-edge state that will be described later on. In the sitting-on-bed-edge state, however, unlike the over-bed-fence state, it is assumed that the moving-object area excessive of a predetermined size is detected beneath the bed. This being the case, the control unit 11 may determine whether the optical flow indicates the over-bed-fence state or the sitting-on-bed-edge state on the basis of the size of the moving-object area detected beneath the bed. For example, the control unit 11 may presume that the watching target person is in the over-bed-fence state in distinction from the sitting-on-bed-edge state if detecting a first predetermined quantity or a larger quantity of optical flow toward the outside from the inside of the watching-target-person detectable area in the vicinity of the edge of the watching-target-person detectable area and when an optical flow quantity detected beneath the bed (under the watching-target-person detectable area in the present embodiment) and indicating a moving quantity excessive of a predetermined magnitude is not over a predetermined quantity.

(c) Sitting-On-Bed-Edge State

FIG. 10 illustrates one example of the optical flow detected when the watching target person becomes the sitting-on-bed-edge state. As depicted in FIG. 10, when the watching target person just becomes the sitting-on-bed-edge state, it is assumed that the motion occurs at the edge of the bed and in the vicinity of the lower portion thereof in the moving images 3 acquired in step S101. Therefore, it can be assumed that the watching target person lust becomes the sitting-on-bed-edge state, during which the optical flow as illustrated in FIG. 10 is detected in step S102.

Then, in step S103, the control unit 11 presumes the sitting-on-bed-edge state of the watching target person when detecting the moving-object including the body part moving to the edge from the inside of the watching-target-person detectable area described above and the body part moving to the outside from the inside of the watching-target-person detectable area. As described above, the watching-target-person detectable area defines the range of the behavior of the watching target person on the bed. Hence, it can be assumed that the watching target person moves to the edge of the bed and just becomes the sitting-on-bed-edge state in the case of detecting the moving-object described above.

To give a specific example of this process, after the optical flow toward the outside from the inside of the watching-target-person detectable area has been detected within the watching-target-person detectable area, the optical flow is detected in this direction continuously for a predetermined or longer period of time, and the optical flow having a magnitude (vector) acting toward the lower portion of the bed (in a downward direction on the sheet surface of FIG. 10 in the present embodiment) outwardly of the watching-target-person detectable range can be eventually detected outside the watching-target-person detectable range, in which case the control unit 11 estimates that the moving-object including the body part moving to the edge from the inside of the watching-target-person detectable area and the body part moving to the outside from the inside of the watching-target-person detectable area can be detected, and may presume the sitting-on-bed-edge state of the watching target person.

Note that the predetermined period of time serves as an index for estimating whether or not the optical flow is continuously detected when presuming the sitting-on-bed-edge state of the watching target person. The predetermined period of time maybe set beforehand, may also be set by the user, may further be set by the user in a way that selects the time from given periods of time and may yet further be properly set corresponding to the embodiment.

Herein, similarly to the case of the over-bed-fence state described above, if the body part overreaches the edge of the bed, there is the possibility of satisfying the condition for presuming the sitting-on-bed-edge state. In this case, however, it is assumed that the size of the foreground area extracted by the background difference method is smaller than in the case of the over-bed-fence state where the entire body moves.

Such being the case, similarly to the case of the over-bed-fence state, the control unit 11 functions as the image processing unit 22, and may detect the foreground area in the acquired moving images 3 by the background difference method of separating the foreground from the background. Then, the control unit 11 functions as the behavior presuming unit 23, and may presume the sitting-on-bed-edge state of the watching target person in distinction from such a state that the body part of the watching target person overreaches the edge of the bed by determining whether or not the foreground area detected in the moving-object area covering the existence of the moving-object detected based on the optical flow exceeds the predetermined size.

Specifically, if the foreground area in the moving-object area does not exceed the predetermined size, the control unit 11 may presume that the watching target person is in the state of the body part overreaching the edge of the bed. Whereas if the foreground area in the moving-object area exceeds the predetermined size, the control unit 11 may presume not the state where the body part of the watching target person overreaches the edge of the bed but the state where the watching target person tries to sit on the edge of the bed.

This contrivance makes it possible to presume the sitting-on-bed-edge state of the watching target person in distinction from the state in which the body part of the watching target person overreaches the edge of the bed. It is therefore possible to enhance the accuracy when presuming the sitting-on-bed-edge state of the watching target person.

(d) Leaving-Bed State

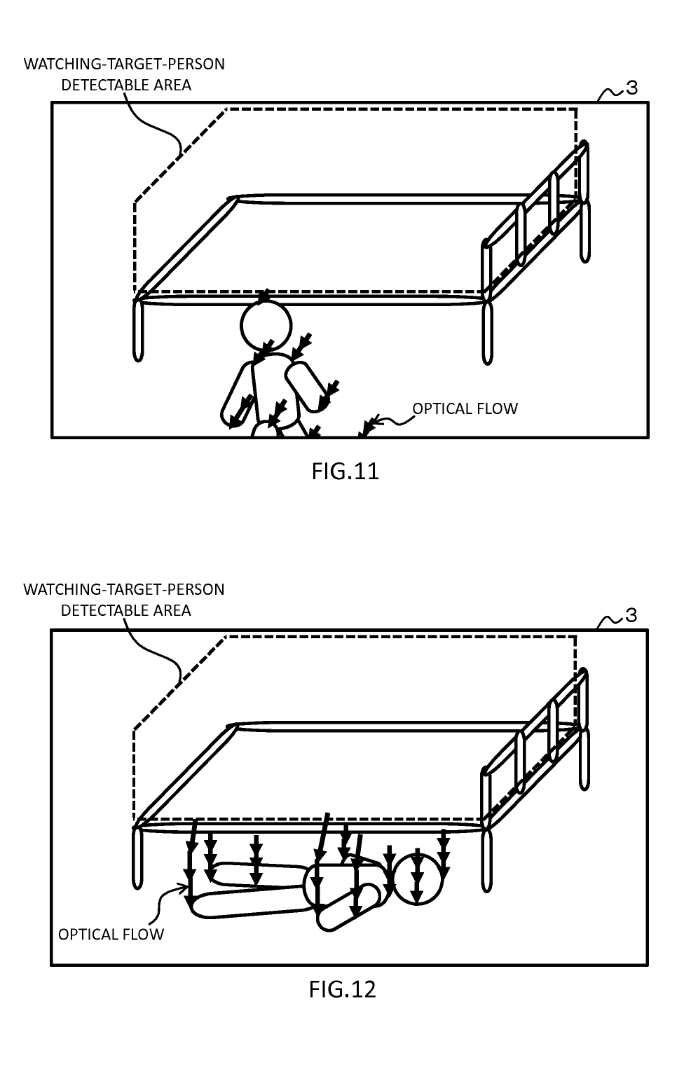

FIG. 11 illustrates one example of the optical flow detected when the watching target person leaves the bed. As depicted in FIG. 11, when the watching target person leaves the bed, it is assumed that the motion occurs in a position distanced from the bed in the moving images 3 acquired in step S101. Therefore, it can be assumed that the optical flow as illustrated in FIG. 11 is detected in step S102 when the watching target person leaves the bed.

Then, in step S103, the control unit 11 presumes the leaving-bed state of the watching target person when detecting the moving-object moving outside the watching-target-person detectable area described above. As described above, the watching-target-person detectable area defines the range of the behavior of the watching target person on the bed. Hence, it can be assumed that the watching target person moves in the place distanced from the bed in the case of detecting the moving-object described above.

To give a specific example of this process, if detecting the optical flow having a magnitude (vector) acting in an arbitrary direction outside the watching-target-person detectable area continuously for a predetermined or longer period of time, the control unit 11 estimates that the moving-object moving outside the watching-target-person detectable area can be detected, and may presume the leaving-bed state of the watching target person.

Note that the predetermined period of time serves as an index for estimating whether or not the optical flow is continuously detected when presuming the leaving-bed state of the watching target person. The predetermined period of time may be set beforehand, may also be set by the user, may further be set by the user in a way that selects the time from given periods of time and may yet further be properly set corresponding to the embodiment.

(e) Come-Down State

FIG. 12 depicts one example of the optical flow detected when the watching target person comes down from the bed. As illustrated in FIG. 12, when the watching target person comes down from the bed, it is assumed that the motion occurs from the edge of the bed to the vicinity of the lower portion thereof in the moving images 3 acquired in step S101. Hence, it can be assumed that the optical flow as illustrated in FIG. 12 is detected in step S102 when the watching target person comes down from the bed.

Further, supposing that the watching target person comes down from the bed and stays in this come-down position, no motion occurs in the position where the watching target person comes down, and it is therefore assumed that the watching target person is treated as an element of the background in the come-down position.

Such being the case, the control unit 11 functions as the image processing unit 22, and may detect the foreground area in the acquired moving images 3 by the background difference method of separating the foreground from the background. Then, the control unit 11 may, in step S103, presume the come-down state from the bed with respect to the watching target person when the foreground area detected by the background difference method disappears with an elapse of time after detecting the moving-object moving beneath the bed from the inside of the watching-target-person detectable area described above. As described above, the watching-target-person detectable area defines the range of the behavior of the watching target person on the bed. Hence, if detecting such a moving-object, it can be assumed that the watching target person comes down from the bed and stays in this come-down position.

To give a specific example of this process, after the optical flow toward the outside from the inside of the watching-target-person detectable area has been detected within the watching-target-person detectable area and if detecting the optical flow having the direction toward the lower portion of the bed in a predetermined range outwardly of the watching-target-person detectable area, the control unit 11 estimates that the moving-object moving to the lower portion of the bed from the inside of the watching-target-person detectable area can be detected. Then, the control unit after not detecting the optical flow having the direction toward the lower portion of the bed, determines the size of the foreground area with respect to the area in which the optical flow having the direction toward the lower portion of the bed is detected so far. When the foreground area becomes smaller than the predetermined size, the control unit 11 estimates the foreground area disappears with the elapse of time, and may presume that the watching target person comes down from the bed.

Note that the predetermined range serves as an index for estimating whether or not the moving-object moving beneath the bed is related to the movement of the watching target person. Further, the predetermined size serves as an index for estimating whether the foreground area disappears or not. These elements may be set beforehand, may also be set by the user, may further be set by the user in a way that selects these elements from given values and may yet further be properly set corresponding to the embodiment.

(f) Others

The states (a)-(e) have demonstrated the situations in which the control unit 11 presumes the respective behaviors of the watching target person on the basis of the position and the direction of the optical flow detected in step S102. The presumption target behavior in the behaviors of the watching target person may be properly selected corresponding to the embodiment. In the present embodiment, the control unit 11 presumes at least any one of the behaviors of the watching target person such as (a) the get-up state, (b) the over-bed-fence state, (c) the sitting-on-bed-edge state, (d) the leaving-bed state and (e) the come-down state. The user (e.g., the watcher) may determine the presumption target behavior by selecting the target behavior from the get-up state, the over-bed-fence state, the sitting-on-bed-edge state, the leaving-bed state and the come-down state. Further, the user may set behaviors other than those described above as the presumption target behaviors.

Herein, the states (a)-(e) demonstrate conditions for presuming the respective behaviors in the case of utilizing the camera 2 installed in the position higher than the bed from rightward in the lateral direction of the bed. The setting items such as the get-up direction, the predetermined area and the watching-target-person detectable area can be determined based on where the camera 2 and the bed are disposed and what behavior is presumed. The information processing apparatus 1 may retain, on the storage unit 12, these items of setting information on the basis of where the camera 2 and the target object are disposed and what behavior is presumed. Then, the information processing apparatus 1 accepts, from the user, selections about where the camera 2 and the target object are disposed and what behavior is presumed, and may specify the setting items for presuming the behaviors of the watching target person. With this contrivance, the user can customize the behaviors of the watching target person, which are presumed by the information processing apparatus 1.

It is to be noted that if detecting an optical flow not satisfying the condition of each of the behaviors in the states (a)-(e), the control unit 11 may presume that the most recently presumed behavior is kept and may also presume that the watching target person is in a behavior state other than the states (a)-(e).

<Step S104>

In step S104, the control unit 11 determines whether or not the behavior presumed in step S103 is the behaving indicating the symptom that the watching target person will encounter with the impending danger. If the behavior presumed in step S103 is the behaving indicating the symptom that the watching target person will encounter with the impending danger, the control unit 11 advances the processing to step S105. Whereas if the behavior presumed in step S103 is not the behaving indicating the symptom that the watching target person will encounter with the impending danger, the control unit 11 finishes the processes related to the present operational example.

The behavior set as the behavior indicating the symptom that the watching target person will encounter with the impending danger, may be properly selected corresponding to the embodiment. For instance, an assumption is that the sitting-on-bed-edge state is set as the behavior indicating the symptom that the watching target person will encounter with the impending danger, i.e., as the behavior having a possibility that the watching target person will come down or fall down. In this case, the control unit 11, when presuming in step S103 that the watching target person is in the sitting-on-bed-edge state, determines that the behavior presumed in step S103 is the behavior indicating the symptom that the watching target person will encounter with the impending danger.

Incidentally, when determining whether or not there exists the symptom that the watching target person will encounter with the impending danger, it is better to take account of transitions of the behaviors of the watching target person as the case may be. For example, it can be presumed that the watching target person has a higher possibility of coming down or falling down in a transition to the sitting-on-bed-edge state from the get-up state than a transition to the sitting-on-bed-edge state from the leaving-bed state. Such being the case, in step S104, the control unit 11 may determine, based on the transitions of the behavior of the watching target person, whether the behavior presumed in step S103 is the behavior indicating the symptom that the watching target person will encounter with the impending danger or not.

For instance, it is assumed that the control unit 11, when periodically presuming the behavior of the watching target person, presumes that the watching target person becomes the sitting-on-bed-edge state after presuming that the watching target person has got up. At this time, the control unit 11 may presume in step S104 that the behavior presumed in step S103 is the behavior indicating the symptom that the watching target person will encounter with the impending danger.

<Step S105>

In step S105, the control unit 11 functions as the notifying unit 24 and issues the notification for informing of the symptom that the watching target person will encounter with the impending danger to the watcher who watches the watching target person.

The control unit 11 issues the notification by use a proper method. For example, the control unit 11 may display, by way of the notification, a window for informing the watcher of the symptom that the watching target person will encounter with the impending danger on a display connected to the information processing apparatus 1. Further, e.g., the control unit 11 may give the notification via an e-mail to a user terminal of the watcher. In this case, for instance, an e-mail address of the user terminal defined as a notification destination is registered in the storage unit 12 on ahead, and the control unit 11 gives the watcher the notification for informing of the symptom that the watching target person will encounter with the impending danger by making use of the e-mail address registered beforehand.

Further, the notification for informing of the symptom that the watching target person will encounter with the impending danger may be given in cooperation with the equipment installed in the facility such as the nurse call system. For example, the control unit 11 controls the nurse call system connected via the external I/F 15, and may call up via the nurse call system as the notification for informing of the symptom that the watching target person will encounter with the impending danger. The facility equipment connected to the information processing apparatus 1 may be properly selected corresponding to the embodiment.

Note that the information processing apparatus 1, in the case of periodically presuming the behavior of the watching target person, periodically repeats the processes given in the operational example described above. An interval of periodically repeating the processes may be properly selected. Furthermore, the information processing apparatus 1 may also execute the processes given in the operational example described above in response to a request of the user (watcher).

The information processing apparatus 1 according to the present embodiment obtains the optical flow from the moving images 3 captured by the camera 2 installed for watching the behaviors of the watching target person on the bed and in the vicinity of the bed. Then, when detecting the moving-object based on the obtained optical flow, it is assumed that the detected moving-object corresponds to the watching target person, and the behaviors of the watching target person on the bed and in the vicinity of the bed are presumed based on the position and the moving direction of the detected moving-object. It is therefore feasible to presume the behavior of the watching target person by the simple method without introducing the high-level image processing technology such as the image recognition.

### §4 Modified Example

The in-depth description of the embodiment of the present invention has been made so far but is no more than the exemplification of the present invention in every point. The present invention can be, as a matter of course, improved and modified in the variety of forms without deviating from the scope of the present invention.

(Utilization of Depth Sensor)

The control unit 11 may utilize depth information obtained by the depth sensor 31 for measuring a depth within the moving images 3 when presuming the behavior of the watching target person in step S103. Namely, the control unit 11 may presume the behavior of the watching target person on the bed or in the vicinity of the bed on the basis of the depth of the moving-object, which is obtained by the depth sensor 31.

A position of the moving-object in a real space, which can be specified based on the optical flow, is not necessarily specified from the moving images 3 acquired in step S101. For this reason, the moving-object specifiable based on the optical flow corresponds not to the behavior of the watching target person existing on the bed or in the vicinity of the bed but to a motion of the object unrelated to the watching target person as the case may be, the object existing on the near side of the watching target person as viewed from the camera.

Such being the case, the control unit 11 utilizes the depth information obtained from the depth sensor 31 and is thereby enabled to determine whether or not the moving-object specifiable based on the optical flow corresponds to the behavior of the watching target person existing on the bed or in the vicinity of the bed. Namely, it is feasible to set a condition of the depth of the area in which the moving-object is detected when presuming each behavior. Therefore, the processing being thus done, the information processing apparatus 1 can enhance the accuracy when presuming the behavior of the watching target person on the bed or in the vicinity of the bed.

According to one aspect, the present embodiment aims at providing the technology of presuming the behavior of the watching target person by the simple method. Then, as discussed above, according to the present embodiment, it is possible to provide the technology of presuming the behavior of the watching target person by the simple method.

1. An information processing apparatus comprising:
an image acquiring unit to acquire moving images captured by a camera installed for watching a behavior of a watching target person on a bed or in the vicinity of the bed;
an image processing unit to obtain an optical flow within the acquired moving images; and
a behavior presuming unit to, when detecting a moving-object based on the obtained optical flow, assume that the detected moving-object corresponds to the watching target person and to presume the behavior of the watching target person on the bed or in the vicinity of the bed on the basis of a position and a moving direction of the detected moving-object.

2. The information processing apparatus according to claim 1, wherein the behavior presuming unit presumes that the watching target person gets up from the bed when detecting the moving-object moving in a get-up direction of the watching target person from within an upper-body detectable area potentially covering existence of an upper half of the body of the watching target person in a state of lying down on the bed.

3. The information processing apparatus according to claim 2, wherein the behavior presuming unit presumes that the watching target person gets up from the bed when detecting the moving-object moving in the get-up direction of the watching target person from within the upper-body detectable area in a watching-target-person detectable area potentially covering existence of the watching target person in the case of the watching target person behaving on the bed.

4. The information processing apparatus according to claim 2, wherein the image processing unit further detects a trajectory of the moving-object by tacking a motion in the moving images, and
the behavior presuming unit presumes the get-up state in distinction from a roll-over state on the bed with respect to the watching target person on the basis of the detected trajectory.

5. The information processing apparatus according to claim 1, wherein the behavior presuming unit, with a fence being provided on the bed, presumes an over-bed-fence state of the watching target person when detecting the moving-object moving to an outside from an inside of a watching-target-person detectable area potentially covering existence of the watching target person in the case of the watching target person behaving on the bed.

6. The information processing apparatus according to claim 5, wherein the image processing unit further detects a foreground area in the moving images by a background difference method of separating a foreground from a background, and
the behavior presuming unit presumes the over-bed-fence state of the watching target person in distinction from a state in which a part of the body of the watching target person overreaches an edge of the bed by determining whether an area occupied by the foreground area detected in a moving-object area covering existence of the moving-object detected based on the optical flow exceeds a predetermined size or not.

7. The information processing apparatus according to claim 1, wherein the behavior presuming unit presumes a sitting-on-bed-edge state of the watching target person when detecting the moving-object including a body part moving to an edge from the inside of a watching-target-person detectable area potentially covering existence of the watching target person in the case of the watching target person behaving on the bed and a body part moving to the outside from the inside of a watching-target-person detectable area.

8. The information processing apparatus according to claim 7, wherein the image processing unit further specifies a foreground area in the moving images by a background difference method of separating a foreground from a background, and
the behavior presuming unit presumes the sitting-on-bed-edge state of the watching target person in distinction from a state in which a part of the body of the watching target person overreaches an edge of the bed by determining whether an area occupied by the foreground area detected in a moving-object area covering existence of the moving-object detected based on the optical flow exceeds a predetermined size or not.

9. The information processing apparatus according to claim 1, wherein the behavior presuming unit presumes the leaving-bed state of the watching target person when detecting the moving-object moving outwardly of a watching-target-person detectable area potentially covering existence of the watching target person in the case of the watching target person behaving on the bed.

10. The information processing apparatus according to claim 1, wherein the image processing unit further specifies a foreground area in the moving images by a background difference method of separating a foreground from a background, and the behavior presuming unit presumes that the watching target person comes down from the bed when the foreground area detected by the background difference method disappears with an elapse of time after detecting the moving-object moving beneath the bed from the inside of a watching-target-person detectable area potentially covering the existence of the watching target person in the case of the watching target person behaving on the bed.

11. The information processing apparatus according to claim 1, wherein the behavior presuming unit presumes the behavior of the watching target person on the bed or in the vicinity of the bed further on the basis of a depth of the moving-object, which is obtained by a depth sensor.

12. The information processing apparatus according to claim 1, further comprising a notifying unit to issue notification for informing a symptom to a watcher for watching the watching target person when the presumed behavior of the watching target person implies the symptom that the watching target person will encounter with an impending danger.

13. An information processing method by which a computer executes:
acquiring moving images captured by a camera installed for watching a behavior of a watching target person on a bed or in the vicinity of the bed;
obtaining an optical flow within the acquired moving images; and
assuming, when detecting a moving-object based on the obtained optical flow, that the detected moving-object corresponds to the watching target person, and presuming the behavior of the watching target person on the bed or in the vicinity of the bed on the basis of a position and a moving direction of the detected moving-object.

14. A non-transitory recording medium recording a program to make a computer execute:
acquiring moving images captured by a camera installed for watching a behavior of a watching target person on a bed or in the vicinity of the bed;
obtaining an optical flow within the acquired moving images; and
assuming, when detecting a moving-object based on the obtained optical flow, that the detected moving-object corresponds to the watching target person, and presuming the behavior of the watching target person on the bed or in the vicinity of the bed on the basis of a position and a moving direction of the detected moving-object.
